(19) United States
(12) Patent Application Publication
(10) Pub. No.: US 2021/0227752 A1
(43) Pub. Date: Jul. 29, 2021

(54) METHOD AND APPARATUS FOR IDENTIFYING AND HARVESTING AGRICULTURAL PRODUCTS

(71) Applicant: Sergio ZANINI, Porcia (Pordenone) (IT)

(72) Inventor: Sergio ZANINI, Porcia (Pordenone) (IT)

(21) Appl. No.: 17/154,692

(22) Filed: Jan. 21, 2021

(30) Foreign Application Priority Data
Jan. 24, 2020 (IT) 102020000001444

(51) Int. Cl. A01D 46/30; B25J 9/16

(52) U.S. Cl. CPC A01D 46/30; B25J 9/1679; B25J 9/1664

(57) ABSTRACT

A method for identifying and harvesting agricultural products involves identifying, as a target, at least one agricultural product, applying a marker to each agricultural product, detecting and storing, for each marker, a set of data defining a tracking and access vector, the set of data forming the tracking and access vector comprising the absolute position of the marker, a versor identifying orientation of the marker and data needed to construct a predefined path to access the marker, and providing at least one harvesting device for harvesting each agricultural product and programming it to reach each agricultural product based on data contained in the tracking vector of each agricultural product.

### CROSS REFERENCE TO RELATED APPLICATION

This application claims the priority benefit of Italian Pat. App. No. 102020000001444, filed on Jan. 24, 2020, which is fully incorporated by reference herein in its entirety.

### FIELD OF THE INVENTION

The present invention is directed to a method and apparatus for identifying and harvesting agricultural products.

### BACKGROUND OF THE INVENTION

As is known, robotized and/or automatic systems are increasingly applied in modern farming industry for managing production plantations. There are multiple applications covering all steps of production, from improving sowing to cultivation and/or harvesting of crops. One of the areas undergoing major developments is automatic harvesting of products, comprising fruits, flowers, vegetables, and the like.

In particular, two main trends may be identified: non-selective systems and selective systems.

In non-selective systems, harvesting is not tracked but indiscriminate; therefore, such harvesting ensures, on the one hand, high productivity but, on the other hand, it may damage both plants and products.

An example of non-selective harvesting is represented by automatic towed and self-propelled grape harvesting machines, which pick the grapes from the vineyards by shaking, combing, and detaching operations.

In selective systems, instead, harvesting is carried out product by product without damaging plants and preserving the quality of products, obviously to the detriment of productivity.

An example of selective harvesting is represented by robots picking strawberries and peppers in greenhouse cultivations.

Use of robotized and/or automatic selective systems in a particularly demanding field as agricultural production, is slowed down by certain technical limitations, such as (a) complexity, (b) poor robustness, in terms of reliability/efficiency, of product identification systems and (c) low productivity due to long product recognition and identification times. Furthermore, a wide variety of agricultural products requires a specific calibration/customization for each type of crop to ensure sufficient efficiency/reliability of the detection system.

An optimized system for strawberries, ensuring good tracking and harvesting percentage, is generally inefficient for egg-plants because, for the system, the two types of crops have too few characteristics in common, such as color, shape and size.

Furthermore, identification systems are quite frequently of the optical type, based on image processing, whereby the presence of leaves hinders operation thereof, both because the leaves may conceal the product and because the leaves and product may have similar colors.

Moreover, for crops where the various steps of growth of flowers and fruits require rather long periods of time (months, for example), while the final ripening takes place in a rather short time period (days or weeks), it is necessary to promptly pick products to guarantee maximum quality. Such crops require highly variable labor commitment from beginning to end of production: medium/low in the early steps of growth because operations may be distributed over a longer period of time, and high in the final step, which requires operations to be carried out within a short period of time.

Automation of final processes must ensure sufficient speed to be economically and qualitatively competitive compared to traditional manual systems.

In these cases, productivity of the system, understood as the number of single products harvested in the unit of time, and efficiency thereof, understood as the percentage of product effectively harvested with respect to that available on the plant, are both essential characteristics.

For example, a system with high productivity, harvesting thousands of apples per hour, but with 60% efficiency, will leave hundreds of untracked/unharvested apples on the trees per hour, requiring, therefore, a subsequent manual control.

### SUMMARY OF THE INVENTION

The need is felt to overcome the above-described drawbacks and limitations.

Such need is met by a method and an apparatus for identifying and harvesting agricultural products as described and claimed herein.

### BRIEF DESCRIPTION OF THE DRAWINGS

Further features and advantages of the present invention will become more comprehensible from the following detailed description of preferred embodiments thereof given by way of non-limiting examples, in which:

FIGS. 1-4 show diagrammatic views of subsequent steps of identifying and harvesting agricultural products according to an embodiment of the present invention, as better described below.

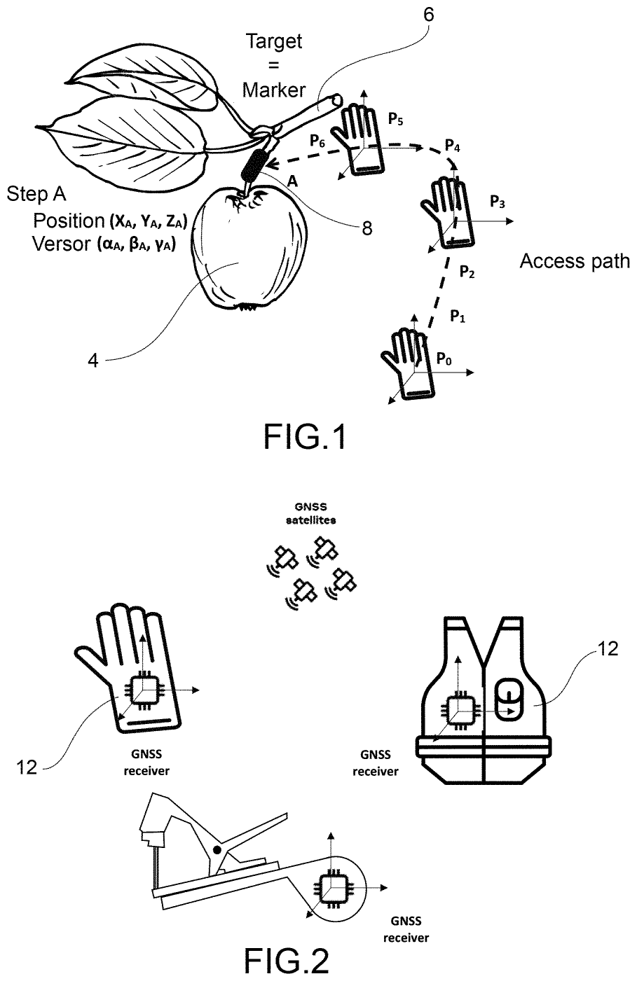

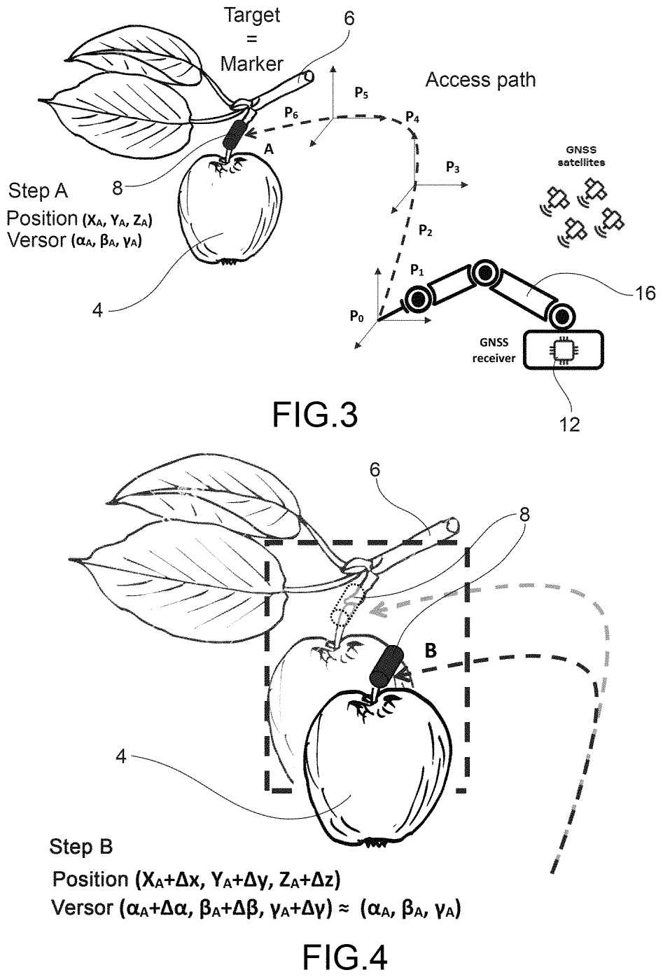

Elements or parts in common of the embodiments described below will be indicated by the same reference numerals.

### DETAILED DESCRIPTION

With reference to the figures, 4 indicates a general agricultural product, whereas 8 indicates a device for harvesting said agricultural product 4.

As mentioned, it is an object of the present invention to provide a method and an apparatus for improving performance in identifying and harvesting agricultural products 4 in terms of production, number of agricultural products 4 harvested in unit of time, in terms of efficiency, percentage of agricultural products 4 effectively harvested with respect to that available, and also in terms of robustness and reliability of recognition of agricultural products 4, irrespective of the type of products and environmental conditions of the agricultural products 4.

Generally, the natural developing process of agricultural products consists of a series of steps distributed over a long period of time and ends with the last step which must often be completed in a short time. The method provided by the present invention tends to distribute the various steps forming the identification and harvesting process in compliance with the times of the natural developing process of the agricultural products 4.

In fact, the method of the present invention provides carrying out preparatory activities during the period of growth and ripening of the agricultural product 4, where the execution time is not critical, and reducing to a minimum, in terms of time, the final harvesting activities.

The ripening process of an agricultural product 4 can be divided into at least two steps: (A) a first set of activities which may be anticipated and aim to prepare the final step; these activities may be distributed throughout the whole period of time preceding final ripening of the agricultural product 4; and (B) the final activity, which must be as quick and efficient as possible to guarantee quality of the harvested agricultural product 4.

The method of the present invention uses the early period of growth of the agricultural products 4 to identify position, orientation, and access path of a point of interest 6 of the agricultural product 4. The point of interest 6 of the agricultural product 4 may be the petiole which connects the agricultural product 4 to the related plant, from which the agricultural product 4 must be separated in order to be harvested.

Time for carrying out the operations in this step is not a critical factor; therefore, it is possible to distribute the work load over a long period of time. If the operation is carried out manually, it is not necessary to concentrate a high amount of labor in a short interval. Likewise, if it is carried out automatically, it is not necessary to use particularly fast automatic systems. The activities carried out and information obtained, stored, and processed will be used for optimizing and accelerating the final step, where implementation time is critical and must be as short as possible.

The time interval between the first step (A), which consists in identifying position, orientation, and path to access the point of interest 6 of the agricultural product 4, and the second step (B), for example, harvesting of the agricultural product 4, or the last step in case of several steps, may vary from a few seconds to days.

The first step A groups all preparatory activities and comprises identifying the points of interest 6 of the agricultural products 4, defined as targets, applying a suitable marker 8, detecting and storing the three absolute spatial coordinates (XA, YA, ZA) of the marker 8, the three directions (angles) which identify the versor (α, β, γ) to access the marker 8, and the coordinates of the points forming the access path for each marker 8. The three absolute spatial coordinates (XA, YA, ZA) of the marker 8 may also be obtained, in an equivalent manner, as relative displacement (XAr, YAr, ZAr) with respect to an absolute known point.

Data is stored in an organized structure, referred to as a tracking and access vector, which is associated with the single marker 8. Thereby, a unique connection is obtained between a point of interest 6 of the agricultural product 4, a marker 8, and a corresponding tracking and access vector. The set of all vectors forms a matrix describing the entire plantation.

Detection of the marker 8, storage of the absolute spatial coordinates of the marker 8, and creation of the versor to access the marker 8 are carried out by a tracking device 12 which may be of various types, as better described below.

As mentioned above, the operations may be carried out manually, semi-automatically, and/or automatically, and may be distributed over a long period of time.

By way of example, a target can be understood as the fruit cutting point for carrying out the harvesting operation. In this case, the target is tracked on the point of interest 6, i.e., on the petiole. Other significant points of interest 6 may be identified as the target as a function of the operations to be carried out on the product (e.g., flower pollination). More generally, the target is given by the agricultural product 4 itself (whether it is a flower or fruit).

By way of example, a marker 8 can be understood as a colored small ring so as to be easily identified among the leaves by an optical system. Various solutions of marker 8 based on different physical principles are described in literature, for example, optical and electromagnetic. In any case, such solutions are known and, therefore, are not the subject of the present invention.

The steps of identifying the point of interest 6, applying the marker 8, detecting and storing the spatial coordinates of the marker 8, creating and storing the vector for tracking and accessing the single marker 8 may be carried out in a manual, semi-automatic or automatic mode, as better described below.

Manual mode: the operator manually applies the marker 8 so as to create a unique connection with the point of interest 6 or target. By way of example, it is no longer important whether the fruit is red or yellow, round or cylindrical, because the system will search for the marker 8 having fixed characteristics, such as shape, color, and material. By using a convenient tracking device 12, the operator repeats the movement carried out when applying the marker 8, spatially moves the tracking device 12 which automatically detects and stores, instant by instant, the data needed to reconstruct the path to access the marker 8. For each marker 8, a set of data is generated, a tracking and access vector, containing all the required information.

The tracking device 12 for detecting and storing the tracking and access vector may be a portable device. A possible embodiment is a “virtual scissor” having similar shape and size to the scissor used during harvesting. The operator simulates the harvesting operation using the “virtual scissor” which records all movements and positions. The automatic harvesting system will use the stored and processed data to reproduce the operator's behavior while optimizing time.

The tracking device 12 for detecting and storing the tracking and access vector may be a wearable device, such as a glove or a bracelet worn directly by the operator.

The tracking device 12 for detecting and storing the tracking and access vector may be a device consisting of two elements, a wearable one, such as a backpack, and a movable part connected to the wearable one mechanically or via radio.

The tracking device 12 for detecting and storing the tracking and access vector may be a device consisting of two elements, one applied to a base containing the tracking system, such as a platform on wheels, and a measuring arm mechanically connected to the base.

The tracking device 12 for detecting and storing the tracking and access vector may be a device consisting of two elements, one applied to a base containing the tracking system, such as a platform on wheels, and a portable and/or wearable device connected via radio to the base.

Semi-automatic mode: the operator is provided with a suitable tracking device 12 to apply the marker 8 while detecting and storing the tracking and access vector containing all required data. When applying the marker 8, the operator spatially moves the tracking device 12 which automatically detects and stores, instant by instant, data needed to reconstruct the path to access the marker 8.

The tracking device 12 for applying the marker 8 while detecting and storing the tracking and access vector may be a gun or an equivalent portable tool.

The tracking device 12 for applying the marker 8 while detecting and storing the tracking and access vector may be a device consisting of two elements, a wearable one, such as a backpack, and a movable part connected to the wearable one mechanically or via radio.

The tracking device 12 for applying the marker 8 while detecting and storing the tracking and access vector may be a device consisting of two elements, one applied to a base containing the tracking system, such as a platform on wheels, and an arm mechanically connected to the base.

The tracking device 12 for applying the marker 8 while detecting and storing the tracking and access vector may be a device consisting of two elements, one applied to a base containing the tracking system, such as a platform on wheels, and a portable and/or wearable device connected via radio to the base.

Automatic mode: the operation is completely automatic and is carried out by a suitable tracking robot/device 12 capable of identifying the objectives, applying the marker 8, detecting and storing the tracking and access vector containing all required data using a tracking system.

By way of example, a tracking system may be a satellite tracking Global Position System (GPS). Various alternative tracking solutions are described in literature based on different principles: RTK GPS differential, UWB systems, cell phone networks, and WIFI networks, with radio-frequency such as LORAN and ARVA. In any case, such known solutions are not the subject of the present invention.

The end result of the first step A is a complete spatial representation of the targets or points of interest 6 and of the agricultural products 4, as well as of the related access paths. It is a table of coordinates and spatial directions identifying the single targets and the respective access path. The number of lines in the table corresponds to the number of markers 8 and agricultural products 4 present.

Regardless of the mode in which the first step is carried out, whether manual, semi-automatic, or automatic, it is a very time-consuming operation. This results in a great number of hours spent by a person if performed manually, or by the device/robot if performed automatically. Generally, such amount of time is incompatible with the need to harvest the product within a limited period of ripening; therefore, it is convenient to perform it beforehand.

The general planting table obtained in step A, or subsequent processing thereof, is used for programming a harvesting device 16.

By way of example, the harvesting device 16 may be a robotized arm provided with a system for searching the marker 8. The marker 8 may be a cylinder enveloping the stem which supports the fruit, and the color of the cylinder may be selected so as to be easily identified among the leaves. The robotized arm or harvesting device 16 is controlled by using the general table, to be positioned close to the marker or target 8. The target searching system may comprise two digital cameras to obtain a stereoscopic view of the marker 8, which are integral with the harvesting device 16.

The optical searching system is positioned close to the marker 8 so that the marker 8 is inside the optical field without the need to carry out a search for it. The probability of this happening is linked to the width of the optical field and reliability of the information stored in the table. The larger the optical field, the greater the possibility to find it, but the greater the distance will be, and time, to reach the final position. The marker 8 may be at the edges and, therefore, the correction distance may be longer. The more recently the table was updated, the shorter the distance will be between the real position and the stored position. By processing images, the system identifies the possible correction of the position and, if necessary, reaching the new position and thus the successive harvesting operation. Various alternative solutions for tracking the target based on different principles are described in literature, including optical, with radio-frequency, and electro-magnetic.

The second (or last) step B consists in, by using the table detected and stored in step A, or a processing thereof, controlling the harvesting device 16 to quickly approach the points of interest 6 and, by using the marker 8, to reach the target to carry out the required operation, for example, harvesting.

It is highly improbable that the target significantly moves from the initially stored position. Weight or external agents, such as wind and rain, may modify the final position of the target only within a limited area. The system for identifying the marker 8 compensates for this displacement, correcting the position previously detected in step A and obtaining the final one (XB, YB, ZB). Oher data contained in the tracking and access vector may also be corrected to improve precision of the system.

By way of example, flowering of crocus, from which saffron is obtained, takes place over a rather long period of time, 3 weeks, while ripening time is quite short, varying from 2 to 5 days, and harvesting is concentrated into a rather limited period of time, 1 or 2 days. Therefore, the preparatory activities of step A, which require long times, may be carried out during flowering and ripening, while the final harvesting activity of step B, may be accelerated due to the previously obtained information. The harvesting device already knows where to go and pick the flowers and knows the shortest path thereto.

Between the two temporally disjointed steps A and B, the system may perform additional operations for processing the general planting table.

By processing data contained in the general table, the optimal path is calculated, at a minimum time, for carrying out the harvesting step as quickly as possible.

By processing data contained in the general table, time for carrying out harvesting, production of the plantation, and distribution thereof are calculated. Such information may be useful for planning the harvesting operation as a function of other parameters, such as weather conditions, level of ripeness, availability of equipment and personnel.

By way of example, further information from other sources may be added to the tracking and access vectors of the table, such as sensors, operators, and other devices for managing the plantation, including irrigation system, fertilization, quality control, and weather.

By way of example, a set of sample measurements may be carried out on the fruit to control the state of health (parasite presence), ripeness, and enter such information in the general table. The gathered information may be used for planning subsequent activities and those of the years to come for optimizing future crops.

The general planting table may be used to carry out operations of controlling and managing the plantation prior to the step of harvesting, eliminating non-compliant products, thinning the leaves, and measuring the state of ripeness of the product.

By way of example, the operation of defoliating a vineyard to ensure correct exposure of the bunches to sun rays in the last ripening step may be carried out using information contained in the general planting table.

The general planting table may be used to perform a simulation of the final harvesting operation. The harvesting device 16 is programmed to carry out a simulation of the operation without harvesting the target (fruit or flower). Therefore, for each target, the device verifies effective reaching and deviation of the actual time from the theoretical one. The system calculates a parameter for each marker, which indicates the efficiency of reaching the marker.

By way of example, as a function of the value obtained for each marker 8, different action may be taken.

Parameter close to 100%: the simulation time is close to the theoretical one. The value of the tracking and access vector in the table is correct, no change.

Parameter from 30% to 70%: the simulation time is significantly higher than the theoretical one. The value of the tracking and access vector in the table may be automatically updated with that detected during simulation.

Parameter lower than 30%: the simulation time is much higher than the theoretical one or the marker 8 has not been reached. The operator is required to intervene to restore optimal conditions. For example, the leaves may have grown, preventing identification of the marker; therefore, it is necessary to clean the area around the target 4/marker 8. The marker may be detached and thus must be restored, carrying out the detection to update the related tracking and access vector, or the operator may have eliminated some targets 4 because they do not meet quality requirements.

By way of example, the operator may use the harvesting device 16 in a learning mode by guiding the robotic arm to perform the required movement until reaching the desired point. Thereby, the system stores the path taken by the operator, and at the desired moment, for example during harvesting, it will be able to repeat it with greater precision and efficiency.

By means of an iterative process of simulation, control and verification, the general planting table is updated from time to time so as to track changes in the plantation conditions and ensure the highest efficiency of the final harvesting operation, both in terms of time and number of targets actually harvested with respect to those available.

At the end of such process, the general planting table is used to program the harvesting device to carry out the final step of the process.

The method of the present invention provides generating and updating a general planting table containing all information needed to optimally carry out the harvesting step, minimizing time for identifying the markers 8 and harvesting the targets 4.

As can be appreciated from the above description, the present invention overcomes the drawbacks described in the prior art.

In particular, the method of the present invention tends to distribute the various steps forming the process of identification and harvesting in compliance with time of the natural developing process of agricultural products.

In fact, the method provides performing preparatory activities during the period of growth and ripening, where execution time is not critical, and reducing to a minimum, in terms of time, the final harvesting activities.

In order to meet specific, contingent needs, those skilled in the art may make several modifications and variations to the method and apparatus described above, without thereby departing from the scope of protection as described and claimed herein.

What is claimed is:

1. A method for identifying and harvesting agricultural products, the method comprising:
identifying, as a target, at least one agricultural product,
applying a marker to each agricultural product,
detecting and storing, for each marker, a set of data defining a tracking and access vector,
wherein said set of data defining the tracking and access vector comprises absolute position of the marker, a versor identifying orientation of the marker and data needed to construct a predefined path to access said marker, and
providing at least one harvesting device for harvesting each agricultural product and programming said at least one harvesting device to reach each agricultural product based on data contained in the tracking and access vector of each agricultural product.

2. The method of claim 1, comprising establishing an optimal harvesting path for each agricultural product, based on data contained in the tracking and access vector of each agricultural product.

3. The method of claim 1, comprising establishing a general planting table for a plurality of agricultural products comprising, for each agricultural product, a corresponding tracking and access vector, and establishing an optimal sequential harvesting path for said plurality of agricultural products.

4. The method of claim 1, comprising establishing a general planting table for a plurality of agricultural products comprising, for each agricultural product, a corresponding tracking and access vector, and processing said general planting table to calculate time of harvesting, production of agricultural products of a plantation, and distribution of the production of agricultural products of the plantation.

5. The method of claim 1, comprising establishing a general planting table for a plurality of agricultural products comprising, for each agricultural product, a corresponding tracking and access vector, and supplementing said general planting table with data from other plantation management and control devices.

6. The method of claim 1, comprising establishing a general planting table for a plurality of agricultural products comprising, for each agricultural product, a corresponding tracking and access vector, and using said general planting table to plan and carry out plantation control and management operations prior to harvesting.

7. The method of claim 1, comprising establishing a general planting table for a plurality of agricultural products comprising, for each agricultural product, a corresponding tracking and access vector, wherein said general planting table is used by the at least one harvesting device to perform a simulation of a harvesting operation and to determine a parameter for each marker, which indicates efficiency in reaching said marker.

8. The method of claim 7, wherein the general planting table is automatically updated after a simulation result.

9. The method of claim 7, wherein, following the simulation result, an update of some tracking and access vectors of the general planting table is required by an operator, or an intervention on the plantation is required to restore conditions for reaching the markers.

10. An apparatus for identifying and harvesting an agricultural product, the apparatus comprising:
at least one marker associated with an agricultural product to be tracked and harvested, said least one marker being identified by a tracking and access vector,
a tracking device for detecting and storing the tracking and access vector of said agricultural product,
wherein the tracking device is a portable device,
wherein the tracking device is configured to apply the marker to the agricultural product,
wherein the tracking device is a wearable device configured to perform a marker application function.

11. The apparatus of claim 10, wherein the tracking device comprises two elements, a wearable element and a movable part connected to the wearable element mechanically or via radio.

12. The apparatus of claim 10, wherein the tracking device comprises two elements, an element applied to a base containing the tracking system, including a platform on wheels, and a measuring arm mechanically connected to the base.

13. The apparatus of claim 10, wherein the tracking device comprises two elements, an element applied to the base containing the tracking system, including a platform on wheels, and a robotic arm mechanically connected to the base.

14. The apparatus of claim 13, wherein the tracking device is configured to perform functions of target identification, marker application, detection and storage of the tracking and access vector, target harvesting.

15. The apparatus of claim 10, wherein the tracking device comprises a robotic harvesting arm which acts as the harvesting device and is activated in a learning mode, an operator manually guiding the robotic harvesting arm so that the tracking and access vector of the targets is stored in the tracking system.
